(19) United States
(12) Patent Application Publication
(10) Pub. No.: US 2013/0095992 A1
(43) Pub. Date: Apr. 18, 2013

(54) CLOSED-CYCLE CONTINUOUS FLOW SEPARATORS, SYSTEMS AND METHODS FOR THE CONTINUOUS ISOLATION OF TARGET CELLS

(71) Applicant: Ezekiel Kruglick, Poway, CA (US)

(72) Inventor: Ezekiel Kruglick, Poway, CA (US)

(73) Assignee: Empire technology Development LLC, Wilmington, DE (US)

(21) Appl. No.: 13/395,106

(22) PCT Filed: Oct. 18, 2011
(86) PCT No.: PCT/US11/56734

§ 371 Date: Mar. 8, 2012

(51) Int. Cl. B04B 11/02; B04B 15/02; B04B 11/00

(52) U.S. Cl. 494/13; 494/32; 494/23

(57) ABSTRACT

Provided are closed-cycle continuous flow separator systems for isolating target cell populations, which comprises in operable connection, a binding area for binding a target cell to a binding particle; a first continuous flow centrifuge for separating target cell bound binding particles from non-target cells; a de-binding area for de-binding the target cell from the binding particle; and a second continuous flow centrifuge for separating the target cell from the binding particle.

### BACKGROUND OF THE DISCLOSURE

Stem cells are omnipotent cells that can differentiate into a full range of other cell and tissue types. In general, desirable cells are separated from undifferentiated or other cells using magnetic beads. In such processes, binding beads are typically mixed into a test tube, separated magnetically or via a column, and then various fractions poured off and filtered. The beads are then de-bound manually, for example chemically by introducing something that dissolves the binder, and the beads are recovered manually, for example using a magnet. Bead separation is, however, typically a small batch process that is unsuitable to continuous processing or large numbers of separation cycles.

### BRIEF DESCRIPTION OF THE FIGURES

FIG. 1 depicts a schematic diagram of an illustrative embodiment of a closed-cycle continuous flow separator system.

FIG. 2 depicts a schematic diagram of the closed-cycle continuous flow separator system, shown in FIG. 1, to which a bioreactor is connected.

FIG. 3 depicts a schematic diagram of an illustrative example of the continuous flow centrifuge employed in the closed-cycle continuous flow separator systems of the present disclosure.

FIG. 4 depicts a schematic diagram of an illustrative embodiment of a closed-cycle continuous flow separator system that is arranged in a parallel configuration.

FIG. 5 depicts a schematic diagram of an illustrative embodiment of a closed-cycle continuous flow separator system that is arranged in a series configuration.

FIG. 6 shows a block diagram illustrating an example computing device arranged for controlling the configuration of a closed-cycle continuous flow separator system.

### DETAILED DESCRIPTION OF THE DISCLOSURE

The present description sets forth various examples along with specific details to provide a thorough understanding of claimed subject matter. It will be understood by those skilled in the art, however, that the claimed subject matter may be practiced without some or more of the specific details disclosed herein. Further, in some circumstances, well-known methods, procedures, systems, and components have not been described in detail in order to avoid unnecessarily obscuring claimed subject matter. In the following Detailed Description, reference is made to the accompanying Figures, which form a part hereof. In the Figures, similar symbols typically identify similar components, unless context dictates otherwise. The illustrative embodiments described in the present Detailed Description, Figures, and Claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

The herein-described subject matter sometimes illustrates different components or elements contained within, coupled to, or connected with, different other components or elements. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably coupleable”, to each other to achieve the desired functionality. Specific examples of operably coupleable include but are not limited to physically mateable and/or physically interacting components and/or wirelessly interactable and/or wirelessly interacting components and/or logically interacting and/or logically interactable components.

### Closed-Cycle Continuous Flow Separators

The present disclosure is directed, among other things, to closed-cycle continuous flow separators, systems, and methods for separating and isolating one or more target cell fraction(s) from one or more non-target cell fraction(s). As used herein, the term “closed-cycle continuous flow” refers to separators, systems, and methods in which one or more beads can undergo multiple binding and de-binding events with multiple different cells during the course of uninterrupted operation. Continuous flow centrifuges that can be used in the separators, systems, and methods include centrifuges in which a liquid is continuously fed into a rotor, the sediment is collected, and the supernatant is withdrawn continuously as the rotor rotates. Continuous flow centrifuges are described in U.S. Pat. Nos. 4,011,972; 4,209,405; 3,799,353; 6,521,120; 7,208,048; and 4,447,221 and include, for example, decanter centrifuges such as those described in U.S. Pat. Nos. 4,285,463; 4,449,964; 6,123,656; 4,298,162; 5,197,939; 7,699,766; 8,021,289 and in U.S. Patent Publication No. 2005/0202950.

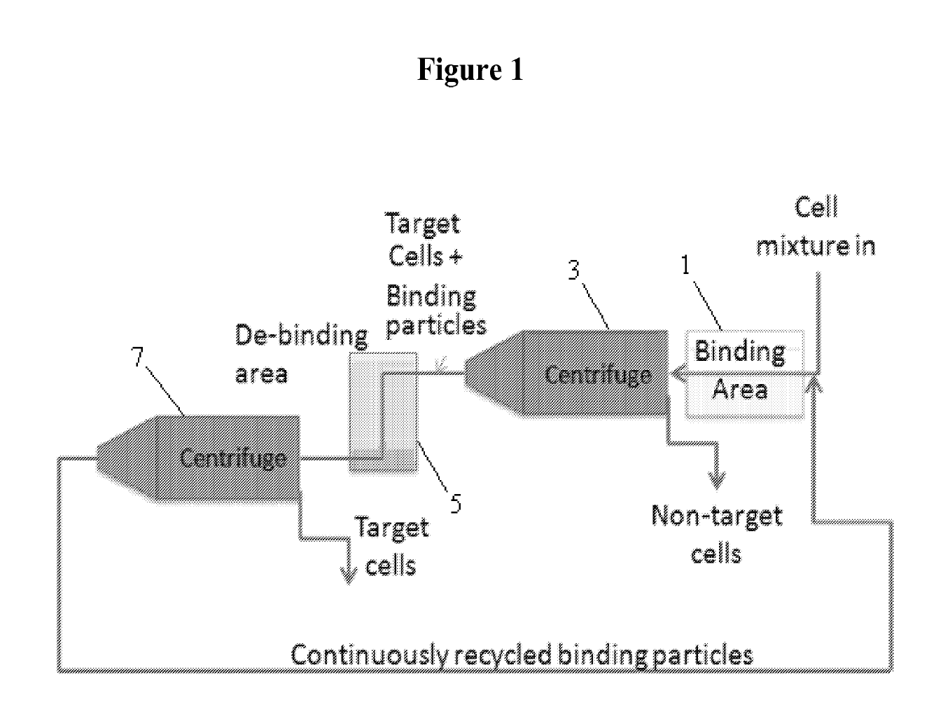

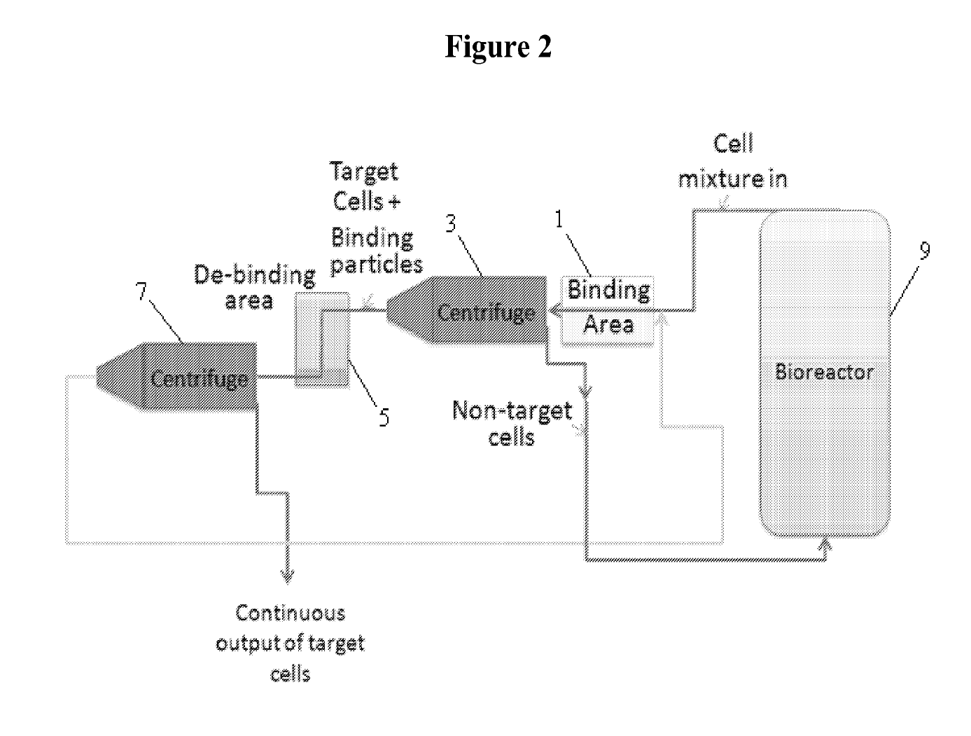

FIG. 1 depicts a schematic diagram of an illustrative embodiment of a closed-cycle continuous flow separator. Shown in continuous operable connection are: a binding area 1, which is configured to accommodate one or more binding particle(s) and to receive a cell mixture from, for example, a bioreactor 9 (see FIG. 2); a first continuous flow centrifuge 3, which receives from the binding area 1 a mixture of unbound cells, unbound particles, and particle-bound cells and which separates the unbound cells from the particles and particle-bound cells; a de-binding area 5, which receives from the first continuous flow centrifuge 3 a cell fraction that includes particles and particle-bound cells; and a second continuous flow centrifuge 7, which receives a mixture of unbound cells and unbound binding particles from the de-binding area 5 and which separates the unbound cells from the unbound binding particles.

By these closed-cycle continuous flow separators, the separated unbound cells may be fed into a receptacle for further processing or use and the separated unbound binding particles may be returned to the binding area for binding to a target cell. Each of the individual components that make up a closed-cycle continuous flow system according to the present disclosure are described in further detail herein, below.

Within certain aspects of these closed-cycle continuous flow separators, the binding area 1 is in operable connection with and upstream of the first centrifuge. Within other aspects of these closed-cycle continuous flow separators, the binding area 1 is a component of and encompassed within the first centrifuge. In the case where the binding area is within the first centrifuge, shear forces are controlled such that the binding particle is capable of specifically binding to a target cell within the mixed cell population. The centrifugal force within the first centrifuge serves to increase contact between binding particles and target cells, which serves to overcome the inhibition of binding that can otherwise occur under conditions of high shear force. This feature permits the continuous flow of mixed cell populations within the binding area coincident with the step of centrifugation.

Within other aspects of these closed-cycle continuous flow separators, the de-binding area 5 is in operable connection with and upstream of the second centrifuge. Within other aspects of these closed-cycle continuous flow separators, the de-binding area 5 is a component of and encompassed within the second centrifuge.

FIG. 2 depicts a schematic diagram of the closed-cycle continuous flow separator shown in FIG. 1 to which a bioreactor 9 is connected. Shown, in operable connection, are a bioreactor 9 wherein a mixed population of cells can be cultured; a binding area 1, which is configured to accommodate one or more binding particle(s) and to receive a cell mixture from, for example, a bioreactor 9; a first continuous flow centrifuge 3, which receives from the binding area 1 a mixture of unbound cells, unbound particles, and particle-bound cells and which separates the unbound cells from the particles and particle-bound cells; a de-binding area 5, which optionally receives from the first continuous flow centrifuge 3 a cell fraction that includes particles and particle-bound cells; and a second continuous flow centrifuge 7, which receives a mixture of unbound cells and unbound binding particles from the de-binding area 5 and which separates the unbound cells from the unbound binding particles.

Connecting a bioreactor to a closed-cycle continuous flow separator permits the continuous circulation and reuse of, for example, non-target cells, including stem cells, while the target cells, including differentiated cells, are continuously removed. It will be understood that a wide variety of mixed cell populations, including blood cells, marrow cells, and tissue derived cells, may be suitably employed in the systems and methods disclosed herein to achieve the separation and isolation of a target cell of interest.

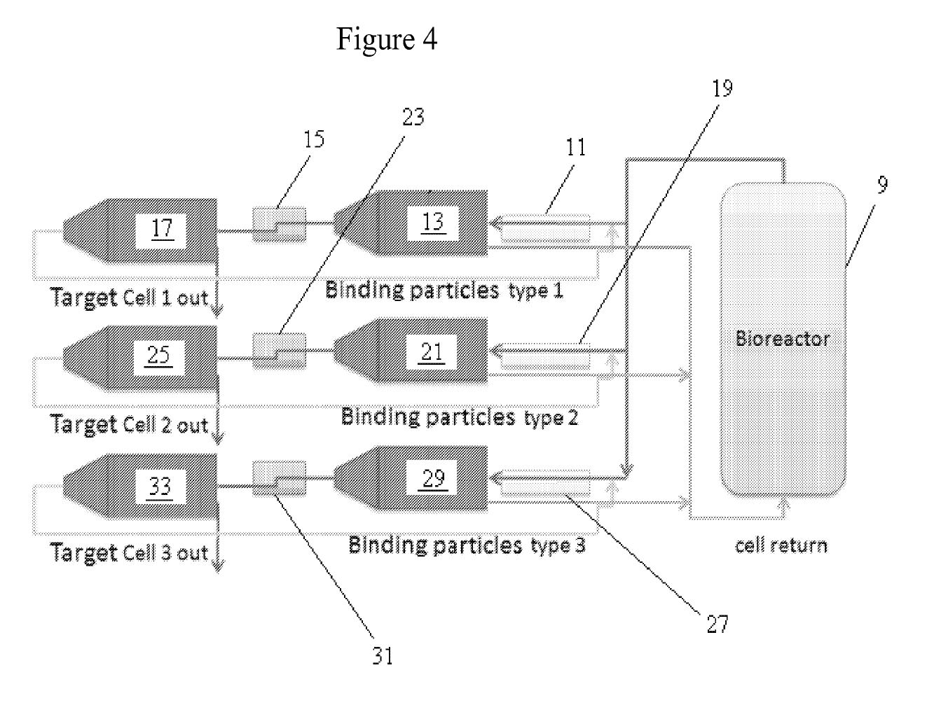

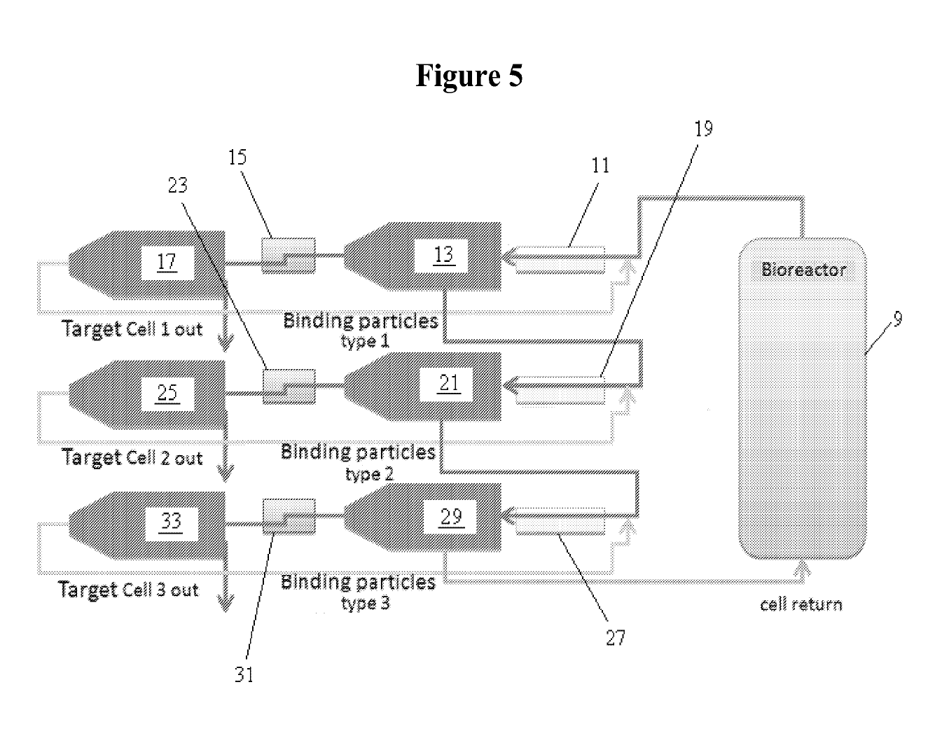

Due to the closed cycle of the system (in contrast to batch processing) multiple separators can be set up as individual modules to facilitate the isolation of multiple distinct cell types. As shown in FIG. 4 and FIG. 5, respectively, such multi-module systems can be set up in parallel or in series. It will be understood that a filter or other device may be employed in such setups to prevent the mixing of a binding particle having one binding agent with a binding particle having a second binding agent.

As one example, FIG. 4 depicts a three-module closed-cycle continuous flow separator with each module being connected in a parallel configuration to provide steady streams of multiple cell types yielded from a continuous bioreactor. Shown, in operable connection, is a bioreactor 9 wherein a mixed population of cells may be cultured and which includes target cells that are in need of separation; a first binding area 11, which is configured to receive and accommodate a first binding particle having a first binding agent having specificity for a first target cell; a first continuous flow centrifuge 13, which can receive and separate a mixture of unbound cells and first binding particle-first target cell complexes; a first de-binding area 15, which receives and de-binds first binding particle-first target cell complexes; a second continuous flow centrifuge 17, which receives and separates a mixture of de-bound first target cells and de-bound first binding particles; a second binding area 19, which is configured to receive and accommodate a second binding particle having a second binding agent having specificity for a second target cell; a third continuous flow centrifuge 21, which can receive and separate a mixture of unbound cells and second binding particle-second target cell complexes; a second de-binding area 23, which can receive and de-bind second binding particle-second target cell complexes; a fourth continuous flow centrifuge 25, which can receive and separate a mixture of de-bound second target cells and de-bound second binding particles; a third binding area 27, which is configured to receive and accommodate a third binding particle having a third binding agent having specificity for a third target cell; a fifth continuous flow centrifuge 29, which can receive and separate a mixture of unbound cells and third binding particle-third target cell complexes; a third de-binding area 31, which can receive and de-bind third binding particle-third target cell complexes; and a sixth continuous flow centrifuge 33, which can receive and separates a mixture of de-bound third target cells and de-bound third binding particles.

In the parallel configuration presented in FIG. 4, the cell flow from the bioreactor is split into three streams and directed simultaneously into each of the first, second, and third binding areas. Within these three binding areas, first, second, and third target cells, respectively, bind to first, second, and third binding particles. Unbound cells are separated from particle-bound first, second, and third binding particles in first, third, and fifth centrifuges 13, 21, and 29, respectively. First particles and first particle bound target cells flow from first centrifuge 13 to first de-binding area 15; second particles and second particle bound target cells flow from third centrifuge 21 to second de-binding area 23; and third particles and third particle bound target cells flow from fifth centrifuge 29 into third de-binding area 31. In each of the first, second, and third binding particles and first, second, and third target cells are dissociated in first, second, and third dc-binding areas, respectively, and flow to second centrifuge 17, fourth centrifuge 25, and sixth centrifuge 33 where the binding particles are separated from the target cells. Target cells are collected for use and/or further processing and binding particles are returned to the respective binding areas.

Mixing of the first, second, and third binding particles (depicted in FIG. 4 as bead types 1, 2, 3) is prevented by use of a filter, or similar device, which is positioned between each of the respective initial centrifuges and the bioreactor feed thereby blocks the flow of the binding particles into the bioreactor stream.

As a second example, FIG. 5 depicts a three-module closed-cycle continuous flow separator system in a series configuration. Each of the elements of this configuration is as described for the parallel arrangement of FIG. 4. Differences are that the cell flow from the bioreactor 9 is directed to the first binding area 11, the unbound cells from the first continuous flow centrifuge 13 are fed into the second binding area 19, the unbound cells from the third continuous flow centrifuge 21 are fed into the third binding area 27, and the unbound cells from the fifth continuous flow centrifuge 29 are recirculated back into the bioreactor 9.

It will be understood that other configurations are contemplated by the present disclosure. For example, and depending upon the number of target cells to be isolated, both parallel and series configurations may employ between one closed-cycle continuous flow separator and one hundred closed-cycle continuous flow separators or between one closed-cycle continuous flow separator and ten closed-cycle continuous flow separators. Alternatively, the closed-cycle continuous flow separators may employ one or more multi-stage coaxial continuous flow centrifuge such as those provided by Rousselet Robatel (Annonay, France).

Binding Areas

As indicated above, the closed-cycle continuous flow separators comprise a binding area wherein a binding particle is contacted with and subjected to suitable conditions to permit the binding to a target cell. Depending upon the precise application contemplated, a binding area may be positioned independently from and upstream to a first centrifuge. Alternatively, a binding area may be contained within a first centrifuge.

U.S. Pat. Nos. 5,641,622 and 4,526,515 describe commercial sterile plastic inserts having integral chambers that may be suitably employed as binding areas in the closed-cycle continuous flow separators described herein. The '622 patent describes the suitability of a range of disposable plastic inserts that contain a first receptacle that is useful as a separation chamber and a second receptacle that is useful as a collection bag. These inserts arc commercially available as the Fenwal CS 3000, the Fenwal 4R2230, and the Fenwal 4R2210.

One example of a centrifugal liquid processing system that may be adapted for use in the systems and methods is presented in U.S. Pat. No. 4,146,172. The chamber described in the '172 patent is formed with closely-spaced sidewalls defining flat interior chambers and is mounted on a rotatably driven carriage that is tilted from a parallel arrangement relative to the carriage axis of rotation. This permits the collection of the cellular component of a mixed cell population. The '172 patent describes, among other things, a binding area that is constructed of hemo-compatible plastic bonded to form an interior compartment having an inlet port at one end of the compartment to receive a mixed cell population and an outlet port an a second end of the compartment through which particles, particle bound target cells, and unbound cells can enter the first centrifuge. Within certain aspects of these chambers, the compartment may be configured to contain ribs or other structures that define the flow path of cells and particles within the chamber such that the effective length of the flow path is increased. This design aspect of a binding area enhances the binding interactions between a binding particle and a target cell.

Centrifuges

The closed-cycle continuous flow separators described herein employ one or more centrifuges to achieve (1) the separation of binding particle-bound target cells from unbound cells and (2) the separation of unbound binding particles from unbound target cells. Closed-cycle continuous flow separators that may be suitably employed in the systems and methods disclosed herein have in common that capability of (1) separating particles by mass and/or size and (2) continuously outputting the flow of particles throughout operation (i.e., without the need to stop the centrifugation to retrieve collected particles).

Within certain aspects, centrifuges that may be suitably employed include the Sharples Model T-1 Super Centrifuge and the CEPA Model LE laboratory centrifuge, each of which is described in Dyrkacz and Bloomquist, Energy & Fuels 6:357-374 (1992). The CEPA-LE centrifuge employs a rotor that includes a simple rotating stainless steel cylinder that narrows to an open tube at the top. The tube has holes that are perpendicular to the rotation axis to permit fluid exit. The expelled effluent is retained by an encircling collector ring. A threaded plug, with a narrow inlet, caps the bottom of the rotor. Fluid is injected into the rotor through a nozzle centered in the opening of the bottom cap. A series of radial vanes within the removable bottom cap accelerate the injected fluid to the rotor velocity.

As used herein, the terms “continuous flow centrifuge” or “solid-bowl scroll-discharge centrifuge” refer to a type of centrifuge that separates beads, including un-bound and cell-bound beads, from un-bound cells in one single continuous process. Continuous flow centrifuges typically have a rotating bowl and a conveyor, such as a screw conveyor or scroll, wherein the conveyor operates with a small differential speed relative to the bowl to permit the continuous removal of solid particles, such as beads and cell-bound beads.

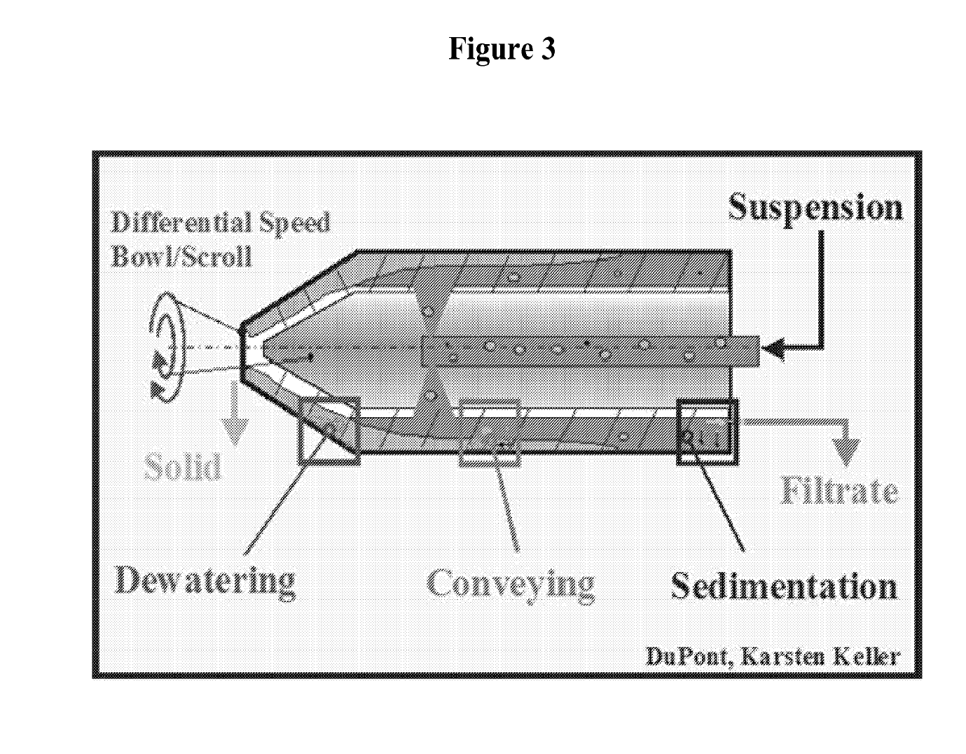

An exemplary continuous flow centrifuge that may be used in the closed-cycle continuous flow separators, systems, and methods disclosed herein is the decanter centrifuge that is presented in FIG. 3 and is described in Keller, Centrifugation in the Chemical Industry, AFS Annual Meeting (2002) and Keller et al., Trends in Biotechnology 19(11):438-441 (2001). Alternative continuous centrifugation systems that may be adapted for use in the closed-cycle continuous flow separators include those described in Lake et al., U.S. Pat. No. 5,641,622 and Fell, U.S. Pat. No. 6,733,433. Suitable continuous flow centrifuges that may be adapted for use in the separators, systems, and methods include those provided by Alpha Laval Separation (Richmond, Va.), Pennwalt Ltd. (Nerul, Navi-Mumbai), SWECO (Florence, Ky.), US Centrifuge Systems (Indianapolis, Ind.), and Centrisys Centrifuge Systems (Kenosha, Wis.).

The continuous flow centrifuges described in the Keller references and within the '622 and '433 patents employ at least three process steps, which occur simultaneously: (1) sedimentation of particles, (2) conveyance of unbound cells and cell medium, and (3) concentration of unbound cells on the conical part of the centrifuge. Each of these aspects of these continuous flow centrifuges is described below, many of which are well known to those of skill in the art.

The differential speed between the bowl and the conveyor provides the conveying motion to collect and remove solids that accumulate at the bowl wall. A mixture of cells and binding particles is fed along a center line to a fixed position within the bowl and is accelerated outwards to join the pond of liquid held on the bowl wall by the centrifugal force. This same force causes the suspended binding particles and binding particle-bound target cells to settle and accumulate at the bowl wall. The unbound cells flows along the bowl to exit the centrifuge—in some cases to return to a bioreactor or directly to a binding area. The opposite end of the bowl is sloped inwards, towards the center, to form a beach to which the binding particles and binding particle-bound target cells are conveyed to exit the bowl at the top of the beach.

The conveyor is typically carried on a hollow axial hub through which the mixture of cells and binding particles passes. The diameter, the number, and the pitch of the conveyor flights are chosen to match the properties of the binding particles as are the depth of the pond, the length of the bowl, the conveyor differential speed, and the angle of slope of the beach, and the desired amount of fluid that may be carried up the beach along with the bead-weighted target cells.

The differential speed is selected for the materials being separated to avoid damage and to match the density ranges. In many cases the differential velocity is low to ensure gentle handling and to minimize damage to the cells. Typically, continuous flow centrifuges are operated with centrifugal forces in excess of 1000 times the force of gravity such that the denser solid binding particles are pressed outwards against the rotating bowl wall and the less dense liquid phase that contains unbound cells forms a concentric inner layer.

It will be understood that a wide variety of system parameters, such as spin velocity, temperature, and flow rate, may be adjusted continuously during the course of a separation run. These parameters may be adjusted manually or through the use of a computer control, the latter of which permits the automated and continual adjustment of each parameter.

For example, the speed and torque of a centrifuge may be adjusted based upon the density and turbidity of the input target cell mixture. As target cells are removed from a re-circulating stream, the stream's density and viscosity decreases accordingly. Thus, a computer control may be used to maintain a given average spin rate through the continuous adjustment of centrifugal torque as target cells are removed from the stream. The differential speed of a centrifuge (which is typically in the range of 20-200 rpm) may be changed based upon the relative population of target cells and may be lowered significantly as the number of target cells decreases. Typically, turbidity of a cell stream may range from 5.0-0.0 McFarland units (which corresponds, respectively, to approximately 150×10⁷ to 0 cells/ml), which values may be monitored at the target cell output using a turbidity sensor. As the McFarland unit number decreases, the differential spin rates should be reduced accordingly.

A computer controller may also be employed to adjust the intensity of a debinding signal input during the course of target cell dc-binding and recovery. The amount of de-binding signal typically increases as the number of target cells recovered decreases in order to ensure the optimal dissociation of binding particle-bound target cells depending upon relative binding affinity. For example, in a system that employs a 25-mer oligonucleotide binding agent, a de-binding temperature that is satisfactory for achieving a majority of binding particle-target cell dissociation must typically be increased to ensure the release of the remaining high-affinity target cells from the bound particles and to reduce rebinding to the relatively larger population of unbound binding particles. Thus, while reduced temperatures may be employed initially to ensure target cell survival, increased temperatures may be employed as separation of target cells progresses to ensure complete dissociation of target cells from binding particles.

A computer controller may also be employed to adjust flow rates as the concentration of target cells decreases. For example, flow rates may be continuously increased, typically by approximately 10-20%, during the course of a cell-separation procedure to account for continuously decreasing cell population densities.

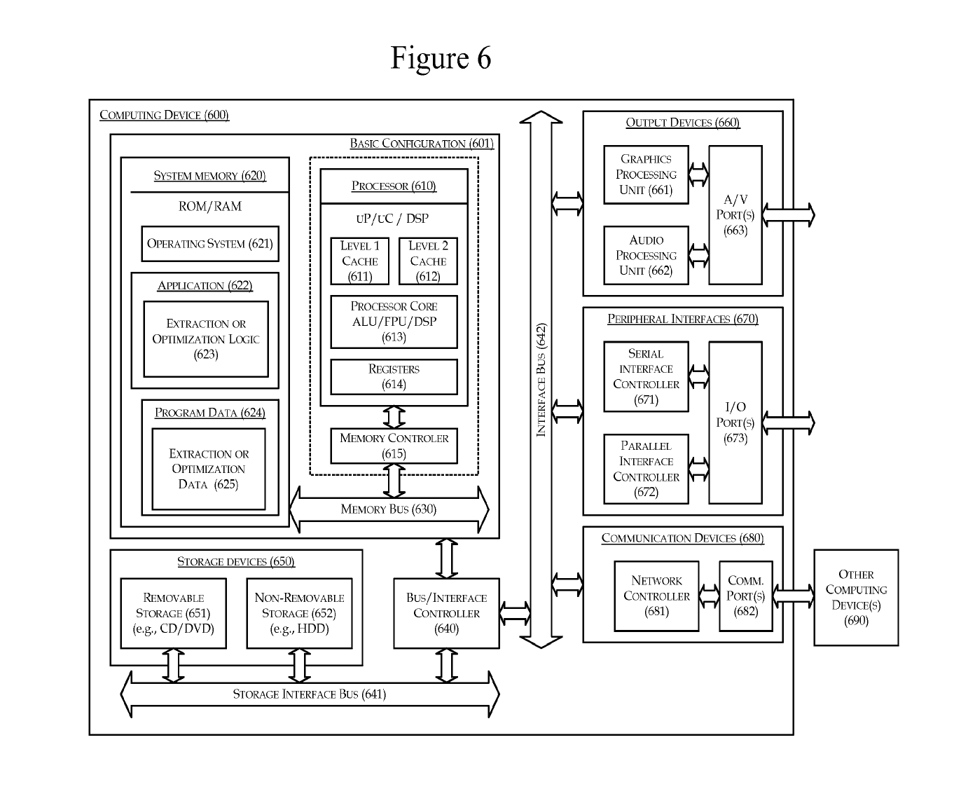

FIG. 6 is a block diagram illustrating an example computing device 600 that is arranged for controlling the configuration of a closed-cycle continuous flow separator system in accordance with the present disclosure. In a basic configuration 601, computing device 600 typically includes one or more processors 610 and system memory 620. A memory bus 630 may be used for communicating between the processor 610 and the system memory 620.

Depending on the desired configuration, processor 610 may be of any type including, but not limited to, a microprocessor (μP), a microcontroller (μC), a digital signal processor (DSP), or any combination thereof. Processor 610 may include one or more levels of caching, such as a level one cache 611 and a level two cache 612, a processor core 613, and registers 614. An example processor core 613 may include an arithmetic logic unit (ALU), a floating point unit (FPU), a digital signal processing core (DSP Core), or any combination thereof. An example memory controller 615 may also be used with the processor 610 or in some implementations the memory controller 615 may be an internal part of the processor 610.

Depending on the desired configuration, the system memory 620 may be of any type including, but not limited to, volatile memory (such as RAM), non-volatile memory (such as ROM, flash memory, etc.) or any combination thereof. System memory 620 may include an operating system 621, one or more applications 622, and program data 624. Application 622 may include a configuration control algorithm 623 that is arranged to generate a command to control the configuration of individual separators within a closed-cycle continuous flow separator system. Program Data 624 includes sensor data 625 that is useful for controlling the configuration of individual separators. In some embodiments, application 622 may be arranged to operate with program data 624 on an operating system 621 to adjust separator parameters such as temperature, flow-rate, and/or velocity based on the sensed parameter(s). The described basic configuration is illustrated in FIG. 6 by those components with in dashed line 601.

Computing device 600 may have additional features or functionality, and additional interfaces to facilitate communications between the basic configuration 601 and any required devices and interfaces. For example, a bus/interface controller 640 may be used to facilitate communications between the basic configuration 601 and one or more data storage devices 650 via a storage interface bus 641. The data storage devices 650 may be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of device 600.

Computing device 600 may also include an interface bus 642 for facilitating communication from various interfaces (e.g., output interfaces, peripheral interfaces, and communication interfaces) to the basic configuration 601 via the bus/interface controller 640. Example output devices 660 include a graphics processing unit 661 and an audio processing unit 662, which may be configured to communicate to various external devices such as a display or speakers via one or more A/V ports 663. Example peripheral interfaces 670 include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication device 680 includes a network controller 681, which may be arranged to facilitate communications with one or more other computing devices 690 over a network communication link via one or more communication ports 682.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

Regardless of the precise configuration of each component, the selection and/or design of a given continuous flow centrifuge permits the removal of separated binding particles and binding particle-bound target cells from the separation zone on a fully continuous basis.

Depending upon the precise cell separation contemplated, continuous flow centrifuges, in particular those continuous flow centrifuges that receive unbound target cells and unbound binding particles, may be further configured with a heating mechanism to elevate the temperature of the centrifuge thereby preventing the re-binding of target cells with binding particles. For example, continuous flow centrifuges may be configured with an energy source (such as, for example, a heat source, an infrared (IR) radiation source, or a radiofrequency (RF) radiation source) to prevent re-binding of target cells with binding particles. When employed, a heating mechanism is typically mounted to a center inlet such that heat is absorbed prior to separation. The precise temperature achieved by heating is based upon the binding parameters of the cell-particle complex and is selected to prevent re-association between an unbound cell and a binding particle.

De-Binding Areas

The closed-cycle continuous flow separators described herein optionally include one or more de-binding area(s) that is either operably connected (1) downstream of a first centrifuge that separates binding particles and binding particle-bound target cells from unbound cells within a mixed cell population and (2) upstream of a second centrifuge that separates unbound binding particles from unbound target cells. Within related closed-cycle continuous flow separators, the de-binding area is contained within the second centrifuge wherein de-binding occurs prior to or coincident with centrifugation and particle separation.

U.S. Pat. Nos. 5,641,622 and 4,526,515 describe commercial sterile plastic inserts having integral chambers that may be suitably employed as de-binding areas in the closed-cycle continuous flow separators described herein. These chambers are described in greater detail herein, above.

As used herein, the term “radio frequency” or “RF” refers to electromagnetic radiation having a frequency of between 3 kHz and 300 GHz, or between 50 kHz and 50 GHz, or between 500 kHz and 5 GHz, or between 5 MHz and 500 MHz. The term “infrared frequency” or “IR” refers to electromagnetic radiation with a frequency of between 1 THz and 430 THz, or between 5 THz and 100 THz, or between 10 THz and 25 THz. RF and IR signals are capable of heating binding particles, such as gold and silver particles, which are within the signal field (for example, the de-binding area shown in FIGS. 1, 2, 4, and 5 or the de-binding area which is a component of the centrifuge).

The use of RF and IR signals for heating gold and/or silver particles is well known in the art. Gannon et al., J. Nanobiotech. 6:2 (2008) and Moran et al., Nano Research 2(5):400-405 (2009) describe the physical basis of gold particle heating by examining the capacitive RF heating properties of gold nanoparticles with respect to their volume fraction and diameter. See, generally, Metaxas, Foundations of Electroheat: A Unified Approach (J. Wiley & Sons: New York, N.Y. (1996)).

Kanzius, U.S. Patent Publication No. 2006/0190063, U.S. Patent Publication No. 2005/02511233, U.S. Patent Publication No. 2005/0251234, and PCT Patent Publication No. WO 2007/027614 describe RF absorbing particles that permit the heating of binding particle-target cell complex. That is, the RF absorbing particles absorb RF energy and the resulting heat leads to the dissociation of a target cell bound to a binding particle through a thermally-sensitive interaction with a binding agent. The RF absorbing materials described in the Kanzius patent publications include electrically conductive materials, such as metals, iron, combinations of metals, irons and metals, and magnetic materials. Kanzius also describes organometallic molecules and organometallics wherein there is at least one bond between a carbon atom and a main group, transition, lanthanide, or actinide metal atom. These organometallic molecules also function as RF absorption enhancers which may be heated by the introduction of RF radiation.

Target cells may also be de-bound from binding particles by reducing a disulfide linkage with the binding agent; employing an enzyme, such as a protease, to specifically cleave the binding agent; and/or adding a competitor to target cell-binding agent binding, such as a soluble antigen, ligand, receptor, etc.

Bioreactors

The closed-cycle continuous flow apparatus and systems disclosed herein may further include or be used in combination with a bioreactor. As used herein, a “bioreactor” may be any device or system used to provide an environment for supporting the growth or production of a population of cells. For example, a “bioreactor” may include a vessel for growing cells/tissues continuously and may include one or more automated systems such as a temperature control system, a pressure control system, a fluid circulation system, etc. A bioreactor may include a sensor, a temperature control device, a liquid addition/removal device, a gas addition/removal device, a mixing/agitating device, a cell growth surface, a centrifugation device, a cell counting/sorting device, a radiant energy source, a controller, and/or other devices. Bioreactors are described generally in Wei-Shou Hu, “Cellular Bioprocess Technology” (University of Minnesota, 2004).

Cell culture bioreactors are generally categorized into two types: (1) those that are used for cultivation of anchorage dependent cells (e.g. primary cultures derived from normal tissues and diploid cell lines) and (2) those that are used for the cultivation of suspended mammalian cells (e.g. cell lines derived from cancerous tissues and tumors, transformed diploid cell lines, hybridomas). In some cases a bioreactor may be modified to grow both anchorage dependent and suspended cells. Ideally any cell culture bioreactor must maintain a sterile culture of cells in medium conditions which maximize cell growth and productivity.

With continuous flow, stirred tank reactors (CSTR or chemostat) fresh medium is fed into the bioreactor at a constant rate, and medium mixed with cells leaves the bioreactor at the same rate. A fixed bioreactor volume is maintained and ideally, the effluent stream should have the same composition as the bioreactor contents. The culture is fed with fresh medium containing one and sometimes two growth-limiting nutrients such as glucose. The concentration of the cells in the bioreactor is controlled by the concentration of the growth-limiting nutrient. A steady state cell concentration is reached where the cell density and substrate concentration are constant.

Suitable bioreactors that may be employed in the closed-cycle continuous flow apparatus and systems include the bioreactors disclosed in U.S. Pat. No. 7,604,987; U.S. Pat. No. 5,155,035; U.S. Pat. No. 5,153,133; U.S. Pat. No. 7,875,448; U.S. Pat. No. 5,002,890; and U.S. Pat. No. 4,894,342 and in U.S. Patent Publication No. 2010/0120136; U.S. Patent Publication No. 2010/0297233; U.S. Patent Publication No. 2009/0280565; U.S. Patent Publication No. 2008/0044850; and U.S. Patent Publication No. 2008/0131959.

Bioreactors typically operate under conditions that resemble in vivo conditions and are designed to provide a constant supply of nutrition and removal of metabolic byproducts. Thus, bioreactors are configured to maintain an organotypic environment to maintain cellular differentiation and optimal function.

Current biorcactors for growing cell tissues arc designed with one or more axis of rotation. For example, U.S. Pat. No. 7,604,987 describes a bioreactor having a chamber for containing cells or tissue cultures within a culture medium. The bioreactor includes a detector capable of detecting a change in one or more metabolites associated with growth of the cell or tissue culture within the chamber and a chamber drive capable of rotating the chamber at a first speed about a first axis and a second speed about a second axis.

U.S. Patent Publication No. 2010/01200136 describes bioreactors that are adapted for rotation for use in microgravity conditions and equipped with an incubation cavity having a small internal fluid volume. The bioreactor includes a humidity chamber or other means of avoiding dehydration as well as substantially fluid-tight closures for access ports that avoid introduction of air bubbles to the incubation cavity. The bioreactor permits long term maintenance of tissue differentiation states in cultures.

U.S. Pat. No. 5,155,035 describes a bioreactor system that employs a tubular housing that contains an internal circularly disposed set of blade members and a central tubular filter all mounted for rotation about a common horizontal axis and each having independent rotational support and rotational drive mechanisms. The housing, blade members and filter are driven at a constant slow speed for placing a fluid culture medium with discrete microbeads and cell cultures in a discrete spatial suspension in the housing. Replacement fluid medium is symmetrically input and fluid medium is symmetrically output from the housing where the input and the output are part of a loop providing a constant or intermittent flow of fluid medium in a closed loop.

U.S. Patent Publication No. 2010/0297233 describes a bioreactor having a gas permeable, closed-loop chamber for cell or tissue culture, and an oscillating means for moving the gas permeable, closed-loop chamber bi-directionally along an axis horizontal to an axis normal to the closed-loop chamber to force convection of cells and fluid in the gas permeable, closed-loop chamber. The bioreactor optionally includes a tissue engineering scaffold, an inlet means, an outlet means, and integrated sensors and/or a plurality of gas permeable, closed-loop chambers for cell or tissue culture.

U.S. Pat. No. 5,002,890 describes a spiral vane perfusion bioreactor in which a vertical chamber, which is intended for use in a microgravity condition, has a central rotating filter assembly and flexible membranes disposed to rotate annularly about the filter assembly. The flexible members have end portions disposed angularly with respect to one another. A fluid replenishment medium is input from a closed loop liquid system to a completely liquid filled chamber containing microcarrier beads, cells and a fluid medium. Output of spent medium is to the closed loop. In the closed loop, the output and input parameters are sensed by sensors; a manifold permits recharging of the nutrients and pH adjustment; oxygen is supplied and carbon dioxide removed, bubbles are removed and the system is monitored and controlled by a microprocessor.

U.S. Patent Publication No. 2009/0280565 describes a high-rate perfusion bioreactor that allows continuous medium feed and extraction of metabolites or other compounds. These bioreactors may be used for both plant cell cultures as well as mammalian cell cultures, insect cell cultures, and bacterial cell cultures. The design of the reactor includes sedimentation columns mounted inside the bioreactor to separate single cells and cell aggregates from the culture medium at a very low shear stress. The operating conditions allow a stable cell/medium separation by maintaining the medium upward velocity equal to or slightly lower than the cell sedimentation velocity.

Bioreactors that may be used in the closed-cycle continuous flow separators and systems include and/or may be modified from those bioreactors that are commercially available such as, for example, the CelliGen 510 and Pro bioreactors manufactured by New Brunswick Scientific (Edison, N.J.) and the BioNet bioreactors of Broadley-James Corporation (Irvine, Calif.).

### Binding Particles

The closed-cycle continuous flow separators and systems described herein are designed to be used in combination with one or more binding particle, each of which contains one or more binding agent having binding specificity for one or more target cells.

As used herein, the term “binding particle” refers to a particle having physical properties such as size, shape, material, density, and mass that may be exploited through continuous flow centrifugation to permit the separation of binding particles and binding particle-bound target cells from unbound cells within a cell population. Binding particles are selected based upon these physical properties such that the sedimentation velocity of a target cell to which it is bound is sufficiently greater than unbound cells within the cell population thereby effecting the separation of target cells from unbound cells when subjected to centrifugation.

The separation of binding particle-bound target cells from unbound cells can be approximated, as follows, by Stoke's equation for the sedimentation of a sphere in a gravitational field:

V=[d²×(σs−σL)×g]÷18N

Where V is the sedimentation rate of the binding particle; d is the diameter of the binding particle; σs is the density of the binding particle; σL is the density of the liquid medium; N is the viscosity of the liquid medium; and g is the gravitational force.

Binding particles increase the effective diameter and density of a target cell to which the binding particle binds thereby increasing its sedimentation velocity. It will be understood that the efficiency of cell separation can be increased by (1) altering the speed and/or radius of rotor used in the continuous flow centrifuge; (2) increasing the density of the liquid medium containing the binding particles and cells, for example by the addition of a density gradient separation medium such as Ficoll-Paque or Percoil; and (3) increasing the time of centrifugation, which may be achieved by decreasing the rate of flow through the centrifuge.

Suitable binding particles for use in the systems and methods disclosed herein are described in U.S. Pat. No. 5,641,622. Binding particles may be composed of a wide variety of materials, such as but not limited to polystyrene, polyethylene, polypropylene, polyacrylamide, cellulose, dextran, latex, plastics, silica gel, glass, metals, such as gold and silver, or combinations thereof. Also contemplated are binding particles manufactured from proteins (e.g., gelatin and albumin), activated carbohydrates (e.g., cellulose, agarose, and p-toluenesulfonyl chloride- or 2,2,2,-trifluoroethanesulfonyl chloride-activated dextran), and liposomes.

In those systems and methods that employ infrared (IR) or radio frequency (RF) energy to release a target cell from a binding particle, the binding particles may be, but are not limited to, gold or silver particles, which are particularly suitable for IR or RF stimulation. Gold particles of 0.2 μm to 1 μm are available from Sigma-Aldrich (St. Louis, Mo.). Aqueous spherical gold particles are available from Ted Pella, Inc. (Redding, Calif.).

Alternatively, in those systems and methods that employ radio frequency (RF) energy to release a target cell from a binding particle, the binding particles may be glass beads that contain RF receiving elements. For example, particles that have a silica core (Precision Colloids, LLC., Cartersville, Ga.) with an outer shell of gold are available from Nanospectra Biosciences, Inc. (Houston, Tex.).

Regardless of the nature of the material employed, binding particles that may be used in the presently described systems and methods share the feature of altering the physical properties of the binding particle-bound target cell such that its density and/or sedimentation velocity are sufficient to effect separation from unbound cells during a continuous flow centrifugation process.

Typically, binding particles are spherical or approximately spherical and have a diameter (or effective diameter, if not spherical) of about 0.1 μm to about 500 μm, or about 1 μm to about 50 μm, or about 5 μm to about 20 μm. The density of binding particles is typically about 0.25 g/cm³ to about 5.0 g/cm³ or about 0.5 g/cm³ to about 2.5 g/cm³. The ratio of binding particles to target cells in a mixed cell population is typically about 1:1000 to about 1000:1, and optionally about 1:100 to about 100:1.

For certain applications, binding particles may be composed of a paramagnetic material, which exhibit a small, positive susceptibility to a magnetic field. Paramagnetic materials are slightly attracted by a magnetic field and do not retain magnetic properties when the external field is removed. Exemplary paramagnetic materials that may be suitably employed in the binding particles disclosed herein include magnesium, magnetite, molybdenum, lithium, and tantalum.

Binding particles containing paramagnetic materials permit the separation of a binding particle and/or binding particle-bound target cell by use of a magnet. Exemplary paramagnetic binding particles are described in U.S. Pat. No. 5,091,206, “Process for Producing Magnetically Responsive Polymer Particles and Application Thereof;” U.S. Pat. No. 5,395,688, “Magnetically Responsive Fluorescent Polymer Particles;” and U.S. Pat. No. 5,283,079, “Process to Make Magnetically Responsive Fluorescent Polymer Particles.” Exemplary suitable paramagnetic particles that may be used to generate binding particles suitable for use in the present systems and methods include those manufactured by Dynal Company (Oslo, Norway).

Regardless of the size, shape, density, and/or constitutive material(s) of the binding particle, a binding particle achieves the capacity for specific binding to a target cell by use of a binding agent that is attached to the surface of the binding particle. As used herein, the term “binding agent” refers to an agent that is capable of forming a specific, yet reversible, interaction with a target cell. Binding agents include, for example, antibodies, antigens, receptors, ligands, hormones, cytokines, and other and other proteins or peptides thereof; glycoproteins; polysaccharides; lipopolysaccharides; low-density lipoprotein (LDL); nucleic acids; lipids; small molecules, and combinations thereof.

A wide range of suitable binding agents that may be used with the binding particles are described in detail in U.S. Pat. No. 5,641,622 (and references cited therein). For example, the '622 patent discloses, among other things, (1) the use of DNA as a binding agent having specificity for T cells and B cells expressing surface receptors that specifically-bind to DNA, (2) the use of various sugars for achieving the specific binding to hematopoietic progenitor cells and selectin protein expressing cells such as leukocytes, (3) the use of proteins, such as human growth and other hormones, for achieving the specific binding to lymphocytes, (4) the use of lipopolysaccharides, such as endotoxin, for achieving the specific binding to cells expressing CD14 antigen, such as blood monocytes, (5) the general use of protein, nucleic acid, carbohydrate, and other antigens, as binding agents for a wide variety of cells of the immune system, such as B cells and T cells, (6) the general use of receptor ligands, including cytokines and growth factors, as binding agents for cells expressing the cognate receptor.

A central feature of all suitable binding agents is that it bind to a target cell with sufficient affinity and/or avidity such that a binding particle-target cell complex is not affected substantially by the centrifugal forces employed to achieve separation of binding particles from unbound cells.

Typically, a binding agent is attached to a binding particle through a methodology that generates a stable bond, such as a covalent bond, ionic bond, or other high affinity bond. For example, binding agents may be attached to binding particles by the methodology disclosed in Habeeb, Biochimie et Biophysica Acta 673:527-538 (1981); Cambier et al., J. Immunol. Methods 51:209-221 (1982); Bonnafous et al., J. Immunol. Methods 58:93-107 (1983); and U.S. Pat. No. 4,415,665. Other suitable methodologies for attaching binding agents to particles arc well known in that art.

Habeeb describes a methodology for generating binding particles by the use of the heterobifunctional reagent, N-succinimidyl 3-(2-pyridyldithio)propionate to achieve the coupling of lysozyme and bovine serum albumin to Sepharose-gelatin. By the method of Habeeb, a protein is reacted with N-succinimidyl 3-(2-pyridyldithio)propionate at the protein's free amino groups to yield 3-(2-pyridyldithio)propionyl-protein, which is then reduced to thiopropionyl-protein and conjugated to 3-(2-pyridyldithio)-propionyl-Sepharose-gelatin through sulfhydryl-disulfide exchange. This methodology may be generally applied to the coupling of proteins, generally, to Sepharose-based binding particles.

Cambier describes a methodology for coupling of phosphorylcholine to gelatin coated plates via the cleavable crosslinking reagent N-succinimidyl 3-(2-pyridyldiothio)propionate (SPDP). This methodology can be broadly applied to the generation of binding particles by coating particles for use in the systems and methods disclosed herein.

Bonnafous describes a methodology for generating binding particles by the conjugation of organomercurial mersalyl to trisacryl beads bearing primary amino groups and the immobilization of thiolated ligands on this matrix through cleavable Hg—S bonds. The Bonnafous methodology is exemplified by binding particles containing concanavalin A thiolated with N-succinimidyl-3-(2-pyridyldithio)-propionate and immobilized on mersalyl-trisacryl and anti-dinitrophenyl antibodies modified with S-acetyl-mercaptosuccinic anhydride and immobilized on mersalyl-trisacryl. The methodology of Bonnafous may be generally applied to the generation of binding particles that are suitable for use in the systems and methods disclosed herein.

Within certain embodiments of the closed-cycle continuous flow separator systems and methods, de-binding of a target cell to a binding particle may be achieved by deactivation of binding agents by the introduction of, for example, an energy source (such as a heat source, light energy, IR radiation, or RF radiation), an inhibitor of binding agent binding to a target cell, or a binding agent-specific protease or other enzyme. Other examples include light of a specific frequency, such as light within an ultraviolet frequency, which may be employed to induce a transition that releases cell-particle binding. Alternatively, binding particles may employ a binding agent that releases from the particle by the introduction of an energy source, an inhibitor, an enzyme, or a compound, such as an azo compound. Typically, interactions between binding agents and target cells that can be disrupted by an energy source (such as a heat source, light energy, IR radiation, or RF radiation) are reversible. That is, the interaction between a binding agent and a target cell can reform upon removal of the energy source.

Particle-bound nucleic acids can be used in those systems and methods that employ heat for de-binding because they can be designed to denature reversibly at low temperatures (e.g., a 25-mer oligonucleotide may be used that is highly specific for a target cell yet can release at approximately 60° C.).

### Target Cells

The closed-cycle continuous flow separators, systems, and methods disclosed herein may be used for the separation and isolation of a wide variety of target cells that are specifically bound to a binding particle. The selection of suitable target cells is well known to those of skill in the art. It will be understood that a wide variety of cells, including blood, marrow, and tissue derived cells, may be suitably employed in the systems and methods disclosed herein.

For example T cells (e.g., helper-inducer and/or suppressor-cytotoxic T-lymphocytes) and B cells (e.g., antibody producing cells) may be separated from other blood components and tumor cells and hematopoietic progenitor cells (e.g., stem cells) may be separated from bone marrow. Additionally, other cell types may be separated from tissue cell preparations such as, for example, lymphokine activated killer cells, tumor infiltration lymphocytes, and/or activated killer monocytes may be isolated from a suitable tissue preparation. The separators and systems may also be used in methods for the separation and/or isolation of tissue culture cell lines, hybridoma cells, antigen-specific lymphocytes, and bacteria and viruses, including infectious bacteria and viruses.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the disclosure. Those with skill in the art will readily appreciate that embodiments of the disclosure may be implemented in a very wide variety of ways. This disclosure is intended to cover any adaptations or variations of the embodiments discussed herein. Therefore, it is manifestly intended that embodiments of the disclosure be limited only by the claims and the equivalents thereof.

Various operations may be described as multiple discrete operations in turn, in a manner that may be helpful in understanding embodiments; however, the order of description should not be construed to imply that these operations are necessarily order-dependent. Also, embodiments may have fewer operations than described. A description of multiple discrete operations should not be construed to imply that all operations are necessary. Also, embodiments may have fewer operations than described. A description of multiple discrete operations should not be construed to imply that all operations are necessary.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood that, unless indicated to the contrary, terms intended to be “open” (e.g., the term “including” should be interpreted as “including but not limited to,” the term “having” should be interpreted as “having at least,” the term “includes” should be interpreted as “includes but is not limited to,” etc.). Phrases such as “at least one,” and “one or more,” and terms such as “a” or “an” include both the singular and the plural.

It will be further understood that where features or aspects of the disclosure are described in terms of Markush groups, the disclosure is also intended to be described in terms of any individual member or subgroup of members of the Markush group. Similarly, all ranges disclosed herein also encompass all possible subranges and combinations of subranges and that language such as “between,” “up to,” “at least,” “greater than,” “less than,” and the like include the number recited in the range and includes each individual member.

While various aspects and embodiments have been disclosed herein, other aspects and embodiments will be apparent to those skilled in the art. The various aspects and embodiments disclosed herein are for purposes of illustration and arc not intended to be limiting, with the true scope and spirit being indicated by the following claims.

1. A closed-cycle continuous flow separator for isolating a target cell population, the closed-cycle continuous flow separator comprising:
a binding area configured to bind binding particles to respective target cells of a cell mixture to form particle-bound cells;
a first continuous flow centrifuge connected to the binding area and configured to separate unbound cells from the binding particles and the particle-bound cells;
a de-binding area connected to the first continuous flow centrifuge and configured to dissociate the particle-bound cells into unbound particles and unbound target cells; and
a second continuous flow centrifuge connected to the de-binding area and configured to separate the unbound particles and the unbound target cells.

2. (canceled)

3. The closed-cycle continuous flow separator of claim 1, wherein the first continuous flow centrifuge is in operable connection with and upstream of the second continuous flow centrifuge.

4. The closed-cycle continuous flow separator of claim 1, wherein the binding area is in operable connection with and upstream of the first continuous flow centrifuge.

5. The closed-cycle continuous flow separator of claim 4, wherein the first continuous flow centrifuge is configured to receive a mixture comprising the unbound cells, the particle-bound target cells, and the particles from the binding area.

6. The closed-cycle continuous flow separator of claim 1, wherein the binding area is a component of the first continuous flow centrifuge.

7. The closed-cycle continuous flow separator of claim 1, wherein the cell mixture is received from a bioreactor that is in operable connection with and upstream of the binding area.

8. The closed-cycle continuous flow separator of claim 7, wherein the first continuous flow centrifuge is configured to separate the particles and the particle-bound cells from the unbound cells.

9. The closed-cycle continuous flow separator of claim 1, wherein the de-binding area is in operable connection with and downstream of the first continuous flow centrifuge.

10. (canceled)

11. The closed-cycle continuous flow separator of claim 1, wherein the dissociation of the particle-bound cells is affected by a de-binding agent or an energy source.

12. The closed-cycle continuous flow separator of claim 11, wherein the dissociation of the particle-bound cells is affected by the de-binding agent, and wherein the de-binding agent is selected from the group consisting of a protein, a lipid, a lectin, a nucleic acid, a carbohydrate, and a small molecule.

13. The closed-cycle continuous flow separator of claim 11, wherein the dissociation of the particle-bound cells is affected by the energy source, and wherein the energy source is selected from the group consisting of a heat source, infrared (IR) radiation, and radio frequency (RF) radiation.

14. The closed-cycle continuous flow separator of claim 13, wherein the energy source is configured to heat the particle-bound cells thereby affecting the dissociation of the particle-bound cells into the unbound particles and the unbound target cells.

15. The closed-cycle continuous flow separator of claim 13, wherein the infrared (IR) radiation has a wavelength of between about 0.7 μm and about 300 μm.

16. The closed-cycle continuous flow separator of claim 15, wherein the infrared (IR) radiation has a wavelength of between about 2.5 μm and about 100 μm.

17. The closed-cycle continuous flow separator of claim 16, wherein the infrared (IR) radiation has a wavelength of between about 10 μm and about 35 μm.

18. The closed-cycle continuous flow separator of claim 13, wherein the radiofrequency (RF) radiation has a wavelength of between about 0.1 mm and about 1.0 m.

19. The closed-cycle continuous flow separator of claim 13, wherein the radiofrequency (RF) radiation has a wavelength of between about 1.0 mm and about 100 mm.

20. The closed-cycle continuous flow separator of claim 13, wherein the radiofrequency (RF) radiation has a wavelength of between about 2.5 mm and about 25 mm.

21. The closed-cycle continuous flow separator of claim 1, wherein the second continuous flow centrifuge is in operable connection with and downstream of the de-binding area.

22. (canceled)

23. The closed-cycle continuous flow separator of claim 1, wherein the second continuous flow centrifuge is in operable connection with and downstream of the first continuous flow centrifuge, wherein the de-binding area is a component of the second continuous flow centrifuge, and wherein the second continuous flow centrifuge is configured to receive a mixture comprising the unbound cells and unbound binding particles from the first continuous flow centrifuge.

24. (canceled)

25. The closed-cycle continuous flow separator of claim 1, wherein the first continuous flow centrifuge and the second continuous flow centrifuge are assembled as a single multi-stage coaxial continuous flow centrifuge.

26-35. (canceled)

36. A system for separating a target cell from a mixed cell population, the system comprising:
a binding particle for specifically binding to a target cell, the binding particle comprising a high density material and a binding agent; and
a closed-cycle continuous flow separator configured to isolate the target cell from the mixed cell population, the closed-cycle continuous flow separator comprising:
a binding area configured to bind the binding particle to the target cell of the mixed cell population to form a particle-bound cell;
a first continuous flow centrifuge connected to the binding area and configured to separate unbound cells from the binding particle and the particle-bound cell;
a de-binding area connected to the first continuous flow centrifuge and configured to dissociate the particle-bound cell into an unbound particle and an unbound target cell; and
a second continuous flow centrifuge connected to the de-binding area and configured to separate the unbound particle and the unbound target cell.

37-63. (canceled)

64. The closed-cycle continuous flow separator of claim 1, further comprising a recycle path configured to recycle the unbound particles by routing the unbound particles to the binding area.

65. The closed-cycle continuous flow separator of claim 64, wherein the recycle path is connected between the second continuous flow centrifuge and the binding area.

66. The system of claim 36, further comprising a computer controller configured to continually adjust at least one of a spin velocity, a temperature, a flow rate, and a de-binding signal of the closed-cycle continuous flow separator.
